(19) United States
(12) Patent Application Publication
(10) Pub. No.: US 2005/0190399 A1
(43) Pub. Date: Sep. 1, 2005

(54) Image output device and image output system

(75) Inventors: Yasushi Nakaoka, Nagano-ken (JP); Masanori Mukaiyama, Nagano-ken (JP); Masaaki Hanaoka, Nagano-ken (JP); Takashi Yamaguchi, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 11/042,357

(22) Filed: Jan. 26, 2005

(30) Foreign Application Priority Data
Jan. 30, 2004 (JP) 2004-22374
Feb. 3, 2004 (JP) 2004-26580
Mar. 23, 2004 (JP) 2004-83779

(51) Int. Cl. G06F 3/12; G06F 9/44; G06F 13/00

(52) U.S. Cl. 358/1.15; 719/321

(57) ABSTRACT

This is a printing terminal that reads and processes printer specification information and EMF files from a portable recording medium. The specific structure is as follows. Specifically, output contents are recorded on the portable recording medium by a drawing command that does not exist in the output device, and an EMF file that has printer specification information in the header is recorded. When the printing terminal detects that the portable recording medium is connected, it does a matching comparison of the printer identification information that the printing terminal has with the printer specification information of the header of the EMF file recorded in the portable recording medium. When the printer specification information and the printer identification information match, the printing terminal reads the EMF file from the portable recording medium and prints.

### BACKGROUND OF THE INVENTION

1. Field of the Invention

The present invention relates to a technology that makes it possible to use an output device with a client computer without installing a driver that is unique to that output device.

2. Description of the Related Art

In recent years, as notebook computers and portable terminals have become more popular, there has been an increase in printing embodiments that perform printing in public places such as airport lobbies and libraries. For example, one embodiment that can be listed is when printing data one wishes to print using a printer that is installed in a public location is temporarily stored together with a password on a server on the internet from a mobile phone, and only when the correct password is input is the stored printing data printed.

However, with the technology described above, it is necessary to install a server for relaying the printing data information between the printing data issuing device used by the user and the printer, so there is the problem of this being very expensive, and the problem that complicated work of server maintenance is required.

Also, when one wishes to perform printing on a printer that is installed in a public place without installing a server, the user must install a printer driver prepared for each printer type in his own computer. In this case, the user must obtain in advance from the internet or a CD-ROM, etc. a printer driver that corresponds to the printer one desires to use, which is a problem because it is very complicated.

These problems are not problems specific to printers, but rather are problems common to various image output devices such as displays and projectors.

### SUMMAY OF THE INVENTION

The present invention was created considering the problems described above, and its purpose is to provide a technology for which it is possible to perform output to an output device that is publicly installed using a simple structure without installing a driver specific to that output device.

To solve at least part of the problems noted above, with the present invention, a first aspect of the invention provides a data output method in an image output device. The method of first aspect of the present invention comprises steps of,
(a) reading first output data from a portable recording medium, wherein the portable recording medium storing the first output data that is described output contents with a drawing command, wherein the drawing command does not depend on the output device;
(b) judging whether the first output data is suitable for output at the output device based on the first output data;
(c) converting the first output data to second output data that is interpretable by the output device, when it is judged that the first output data is suitable for output at the output device;
(d) performing image output processing using the second output data.

With the first aspect of the present invention, the output device is able to perform output regardless of the model of output device because it reads the first output data for which the output contents are described by a drawing command that does not depend on the output device from a portable recording medium.

Also, since the first output data is read from the portable recording medium, it is possible to perform output using an output device without installing an expensive device such as a server, which increases convenience.

As a second aspect of the present invention provides, a portable recording medium storing a computer program so as to be readable by a computer, wherein
the computer program comprises:
a program command that converts the output data that is an image or text to be output into intermediate data that is described with a drawing command, wherein the drawing command does not depend on the output device; and
a program command that specifies the portable recording medium as the saving destination of the intermediate data, regardless of the specification of the saving destination.

With the second aspect of the present invention, a program which is equipped with a function of converting to intermediate data is recorded on a portable recording medium, so there is no need to install an expensive device such as a server to store and distribute this computer program, making it possible to try to hold down expenses.

Also, since the computer program is recorded on a portable recording medium, the user can omit efforts such as installing the computer program in advance on his own computer.

As a third aspect of the present invention provides, A data output method in a portable recording medium that comprises a connection interface for locally connecting both a data generating device that generates data that is either image or text to be output and an output device that outputs either the image or text based on the data, wherein the data output method comprising steps of:
(a) receiving and storing the data from the data generating device;
(b) storing characteristics data that shows specified characteristics of the output device; and
(c) converting the stored data to intermediate data described with a drawing command, wherein the drawing command does not depend on the output device, based on the characteristics data, and transferring the intermediate data to the output device.

With the third aspect of the present invention, by storing the data he wishes to output in the portable recording medium, the user can convert the data to intermediate data that reflects the characteristics of the output device within the portable recording medium. By including a structure that interprets this intermediate data, the output device is able to perform image output. Therefore, the user can output various data format files in a state that is suitable for the output device without installing a driver specific to the output device on his own computer in advance.

As a fourth aspect of the present invention provides, A data output method in a portable recording medium that has a connection interface for locally connecting both a data generating device that generates data that is either image or text to be output and an output device that outputs either the image or text based on the data, the data output method comprising steps of:
(a) storing the data;
(b) converting the stored data to intermediate data that is described with a drawing command wherein the drawing command does not depend on the output device;
(c) detecting that the portable recording medium is connected to the output device; and
(d) outputting the intermediate data to the output device with the detection as the trigger.

With the fourth aspect of the present invention, by connecting a portable recording medium on which data is stored to the output device, the user is able to output data without performing an operation to the output device such as giving output instructions.

With the present invention, the various embodiments described above can be applied in suitable combinations or with parts omitted. Also, in addition to structures as output devices as described above, the present invention may also be structured as an output system that has a data generating device, an output device, and a portable recording medium that sends and receives information between the data generating device and the output device, a computer program for outputting output data to the output device, and a recording medium on which is recorded this computer program so as to be able to be read by a computer. For any of the structures, it is possible to suitably apply each of the embodiments described above. As a recording medium that can be read by a computer, various media can be used, such as flexible disks, CD-ROMs, DVD-ROMs, photo magnetic disks, IC cards, and hard disks.

### BRIEF DESCRIPTION OF THE DRAWINGS

FIG. 1 is an explanatory diagram that shows an embodiment of the printing system of the first embodiment;

FIG. 2 is an explanatory diagram that shows an embodiment of the printing terminal and user PC functional block for the first embodiment;

FIG. 3 is a flow chart that explains the printing process for the first embodiment;

FIG. 4 is a flow chart that explains the printing process for the user PC of the first embodiment;

FIG. 5 is a flow chart that explains the recording contents judgment process for the first embodiment;

FIG. 6 is a flow chart that explains the printing process for the printing terminal of the first embodiment;

FIG. 7 is a flow chart that explains the recording contents judgment process for the second embodiment;

FIG. 8 is an explanatory diagram that shows an embodiment of the printing system structure for the third embodiment;

FIG. 9 is an explanatory diagram that shows an embodiment of the card PC and printer functional block for the third embodiment;

FIG. 10 is an explanatory diagram that shows an embodiment of the printer operating panel for the third embodiment;

FIG. 11 is a flow chart that explains the data storage process for the third embodiment;

FIG. 12 is a flow chart that explains the process of converting to an EMF file for the third embodiment;

FIG. 13 is a flow chart that explains in detail the conversion process for the third embodiment;

FIG. 14 is a flow chart that explains the printing process for the third embodiment;

FIG. 15 is an explanatory diagram that shows an embodiment of the printer and card PC functional block for the fourth embodiment;

FIG. 16 is a flow chart that explains the process of converting to an EMF file for the fourth embodiment;

FIG. 17 is a flow chart that explains the recording contents judgment process for the fourth embodiment;

FIG. 18 is an explanatory diagram that shows an embodiment of an operating panel for a variation embodiment; and

FIG. 19 is an explanatory diagram that shows an embodiment of a printing system of a variation embodiment.

### DESCRIPTION OF THE PREFERRED EMBODIMENTS

A. First Embodiment:

A1. System Summary:

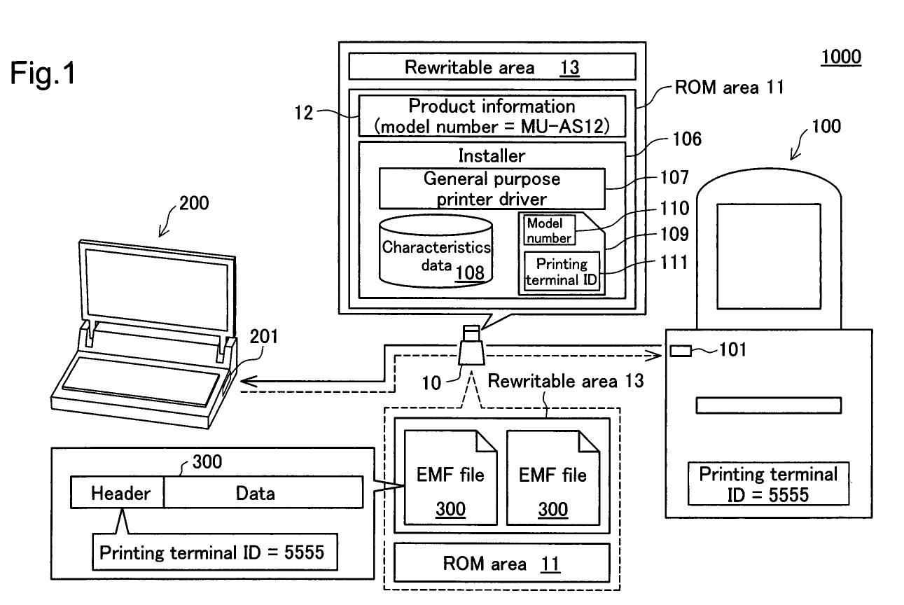

FIG. 1 is an explanatory diagram that shows an embodiment of a printing system 1000 for a first embodiment of the present invention. The printing system 1000 comprises of a printing terminal 100, a user PC 200, and a USB memory 10, and information is sent and received via the USB memory 10 between the printing terminal 100 and the user PC 200, and printing is executed. The printing terminal 100 is formed by combining a printer and a computer. In the printing terminal 100, an individually allocated printing terminal ID “5555” is set in advance. Also, a Windows (registered trademark) operating system (hereafter called Windows OS) is installed in the user PC.

The USB memory 10 is connected in advance to the USB port 101 of the printing terminal 100. As shown by the dotted line balloon in the figure, the memory area of the USB memory 10 consists of read only ROM area 11, rewriteable area 13 for which read and write are possible. Recorded in the ROM area 11 are the product information 12 and the installer 106. The product information 12 is information set for the product such as the model number of the USB memory 10, for example. With this embodiment, the USB memory 10 model number “MU-AS12” is set as the product information 12. The installer 106 consists of a general purpose printer driver 107, the characteristics data 108, and the setting information 109. With the characteristics data 108, data that shows specified characteristics of the printing terminal 100 is defined. Embodiments of specified characteristics include the paper size or resolution supported by the printing terminal 100, whether or not there is a both side printing function, and whether or not there is a color printing function, etc. As shown in the figure, the setting information 109 has the model number 110 and the printing terminal ID 111 recorded. These pieces of information have the USB memory 10 model number “MU-AS12” and the printing terminal ID “5555” recorded in advance.

As shown by the solid line arrow, the user removes the USB memory 10 that is connected to the USB port of the printing terminal 100 and inserts it in the user PC 200 instead. When the user PC 200 detects that the USB memory 10 is connected to the USB port 201, with the plug and play function, the USB memory 10 is automatically recognized as a USB device, and with the auto run function, installation of the general purpose printer driver 107 and the setting information 109 is performed.

When installation by the installer 106 has ended, the user performs printing from the application printing menu the same as when performing printing normally. When the user PC 200 receives printing instructions from the user, it references the installed setting information 109 and generates an EMF file 300 that includes the printing terminal ID in the header. With this embodiment, we created an EMF file, but it is also possible to use a PDF file, for example.

The user PC 200 references the setting information 109 and acquires the model number 110, and of the devices that are connected to the user PC 200, the device that has the model number “MU-AS12” is identified, and this device is set as the saving destination for the EMF file. Specifically, the USB memory 10 is automatically specified as the saving destination of the EMF file. As shown by the dotted line balloon in the figure, the EMF file 300 is recorded in the rewritable area 13 in the USB memory 10. The printing terminal ID “5555” is included in the header of the EMF file 300. Also, for the ROM area 11, there is no change from before the EMF file 300 is recorded.

As shown by the dotted line arrow in the figure, the user removes the USB memory 10 that is connected to the USB port 201 of the user PC 200 and inserts it instead into the USB port 101. When the user PC 200 detects that the USB memory 10 has been removed, files that are installed via the USB memory 10, such as the general purpose printer driver 107, the characteristics data 108, and the setting information 109, are all uninstalled.

When the printing terminal 100 detects that the USB memory 10 is connected, a judgment is made of whether an EMF format file is recorded in the rewritable area 13 of the USB memory 10, and whether or not the EMF file is suitable for printing with the printing terminal 100. This judgment process will be described later. When the EMF file is suitable for printing with the printing terminal 100, the printing terminal 100 read the EMF file 300 from the USB memory 10, and the EMF file 300 is converted to a RAW format, and printing is executed.

A2. Functional Block:

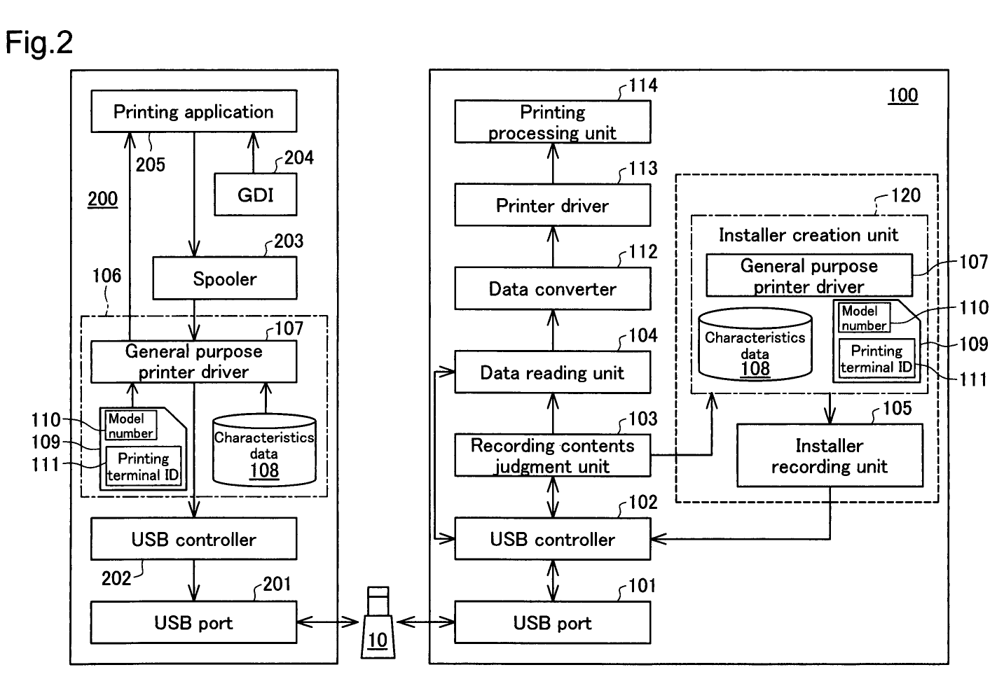

FIG. 2 is an explanatory diagram that shows an embodiment of the printing terminal 100 and the user PC 200 functional block for this embodiment. The user PC 200 consists of the USB port 201 and the USB controller 202 as hardware, and the spooler 203, the GDI 204, the printing application 205, the general purpose printer driver 107 installed from the USB memory 10, the characteristics data 108, and the setting information 109 as software.

The USB controller 202 is a controller for controlling the USB devices that are connected to the USB port 201.

The printing application 205 is software that comprises text creation software or spread sheet software, or alternatively, printing software that is image processing software. When there are printing instructions from the user, the printing application 205 calls the drawing command of the GDI 204 which is one of the modules that form the OS kernel, and generates an EMF format file. When creating an EMF file, the printing application 205 uses the characteristics data 108, and makes printing settings such as paper size and resolution settings, and also references the setting information 109 and includes the printing terminal ID of the printing terminal which is to perform printing in the header of the EMF file.

The general purpose printer driver 107 references the setting information 109 and acquires the EMF file saving destination information from the model number 110. With this embodiment, the model number of the USB memory 10 is set for the model number 110, so the USB memory 10 is identified as the saving destination. The general purpose printer driver 107 reads in sequence the EMF files that are stored in the spooler 203 and writes these to the USB memory 10.

The printing terminal 100 consists of the USB port 101, the USB controller 102, the recording contents judgment unit 103, the data reading unit 104, the data converter 112, the printer driver 113, and the printing processing unit 114. The recording contents judgment unit 103, the data reading unit 104, the data converter 112 and the printer driver 113 is structured as software.

The USB controller 102 is a controller for controlling the USB devices that are connected to the USB port 101.

When the recording contents judgment unit 103 detects that the USB memory 10 is connected to the USB port 101, a judgment is made of whether or not an EMF file is recorded in the USB memory 10. Furthermore, when an EMF file is recorded in the USB memory 10, the header of the EMF file is referenced, and a judgment is made of whether or not this is a file that is suitable for printing with the printing terminal 100. Specifically, with this embodiment, if the printing terminal ID of the host device is set for the header of the EMF file, it is judged that a format that is suitable for the host device, specifically, an EMF file based on the characteristics data 108 of the printing terminal 100 is created. Also, when an EMF file is not recorded in the USB memory 10, or when an EMF file is recorded but it is judged that this is not a format that is suitable for the printing terminal 100, the recording contents judgment unit 103 displays an error message and stops processing.

When it is judged by the recording contents judgment unit 103 that an EMF file that is suitable for printing with the host device is recorded in the USB memory 10, the data reading unit 104 reads the EMF file and transfers this to the data converter 112.

The data converter 112 acquires the device context of the printing terminal 100 from the printer driver 113, and reproduces the printing contents using a GDI command that is recorded in the EMF file. The printer driver 113 creates RAW data that can be interpreted by the printing terminal 100 according to the printing contents, and transfers this to the printing processing unit 114. The printing processing unit 114 prints the transferred RAW data.

With this embodiment, when an EMF file is not recorded in the USB memory 10, or when an EMF file is recorded but it is judged that this is not a format that is suitable for the host device, the printing terminal 100 displays an error message and stops processing, but in this case, it is also possible to create an installer and to record this in the USB memory 10. By installing the general purpose printer driver 107 and the setting information 109 from the USB memory 10 to the user PC 200, the user is able to generate the contents he wishes to print as an EMF file that is suitable for printing with the printing terminal 100.

To realize the processing described above, as shown by the dotted line frame in the figure, the printing terminal 100 comprises an installer creating unit 120 and an installer recording unit 105. The installer creation unit 120 acquires the printing terminal ID of the printing terminal 100 and the model number of the USB memory 10, and creates the setting information 109 and the installer creation unit 120 creates an installer that includes the setting information 109, the general purpose printer driver 107, and the characteristics data 108. The installer recording unit 105 records the created installer on the USB memory 10. This process will be explained with the second embodiment.

A3. Printing Process:

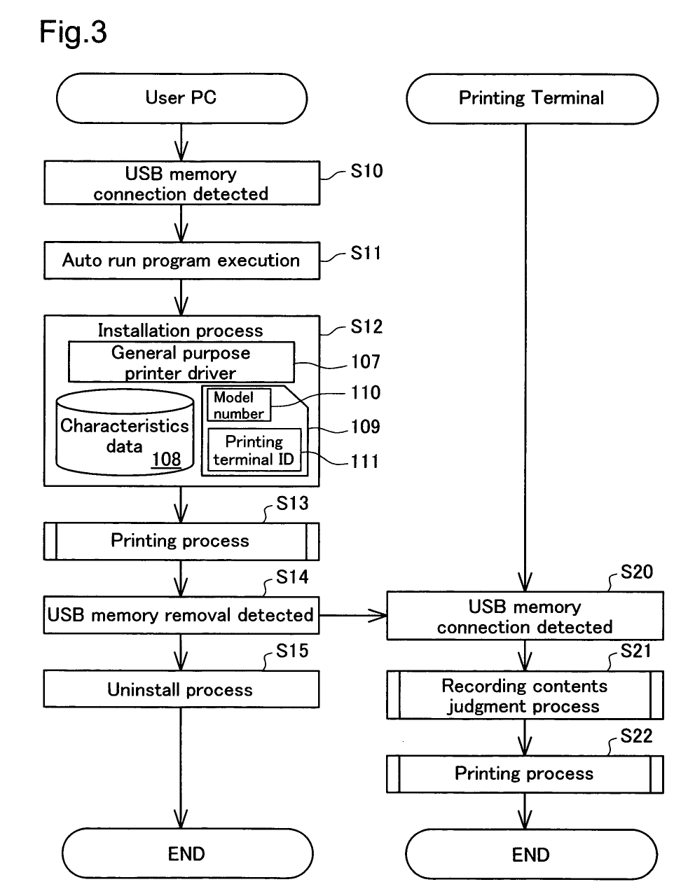

FIG. 3 is a flow chart that explains the printing process of this embodiment. This process is performed by the user PC 200 and the printing terminal 100 sending and receiving data via the USB memory 10.

When the user PC 200 detects that the USB memory 10 is connected (step S10), it executes the auto run program that is recorded in the USB memory 10 (step S11). When this auto run program is executed, an installer that contains the general purpose printer driver 107, the characteristics data 108, and the setting information 109 is transferred from the USB memory 10 to the user PC 200. The user PC 200 performs installation processing (step S12), activates the general purpose printer driver 107, and executes printing processing from the printing application 205 (step S13). With the printing process, the user PC 200 creates the EMF file and saves in the USB memory 10. Details of this process will be described later.

When saving of the EMF file to the USB memory 10 has ended, the user removes the USB memory 10 and then inserts it into the printing terminal 100.

When the user PC 200 detects that the USB memory 10 has been removed (step S14), all of the installed data, for example, the general purpose printer driver 107, is uninstalled (step S15).

When the printing terminal 100 detects that the USB memory 10 is connected (step S20), it judges the recording contents of the USB memory 10 (step S21), and when an EMF file of a format that is suitable for printing with the printing terminal 100 is recorded in the USB memory 10, the printing processing of that EMF file is executed (step S22). Details of the recording contents judgment process of step S21 and of the printing process of step S22 will be described later.

A3-1. Printing Process by the User PC

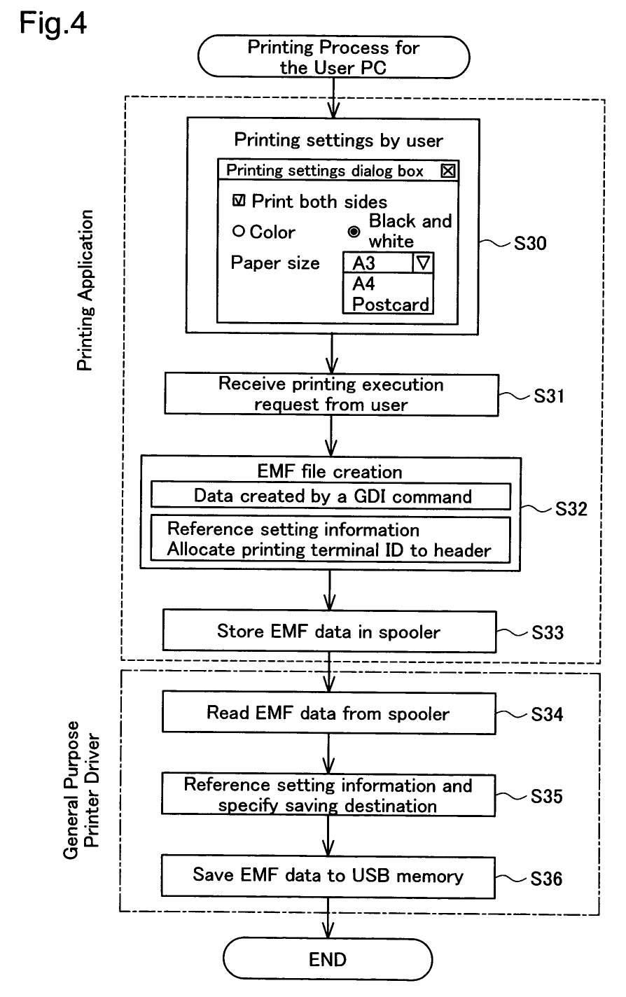

FIG. 4 is a flow chart that explains the printing process of the user PC 200 with this embodiment. This process correlates to step S13 of FIG. 3. [0043] The user PC 200 performs printing settings as needed (step S30) before printing by the printing application 205. The figure shows an embodiment of a settings dialog box that is displayed on the monitor during printing setting. This settings dialog box is displayed by the working of the general purpose printer driver 107 based on the characteristics data 108 installed from the USB memory 10. With this embodiment, we made it possible to select whether or not both sides are printed, specification of color or black and white, and paper size.

Next, the printing application 205, for example by pressing of the printing button, receives a request for printing execution from the user (step S31), creates EMF data that correlates to the printing contents by a GDI command, references the setting information 109, allocates a printing terminal ID to the header, and creates an EMF file (step S32). Then, the created EMF file is stored at the spooler 203 (step S33).

The general purpose printer driver 107 reads the EMF file from the spooler 203 (step S34), references the setting information 109, acquires the model number of the save destination device, and identifies the saving destination of the EMF file (step S35). With this embodiment, the model number of the USB memory 10 is set as the saving destination device, so the user PC 200 saves the EMF file in the USB memory 10 (step S36).

A3-2. Recording Contents Judgment Process:

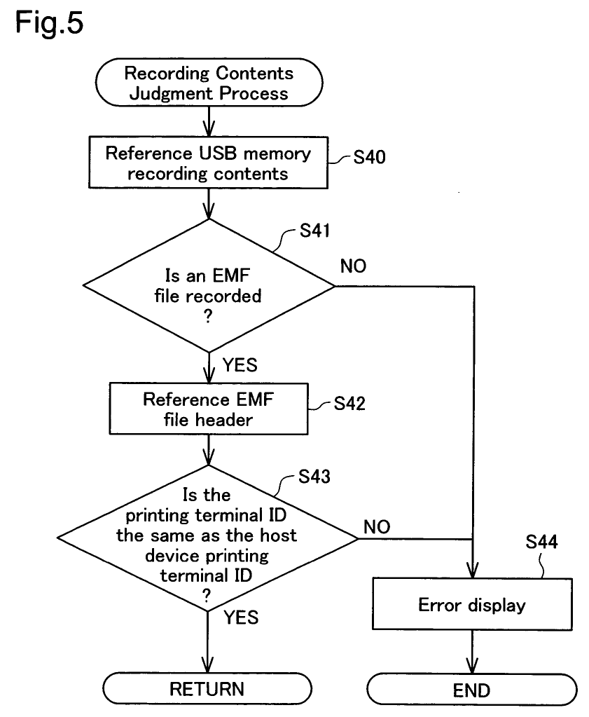

FIG. 5 is a flow chart that explains the recording contents judgment process for this embodiment. FIG. 3 shows the process that correlates to step S21.

The printing terminal 100 references the recording contents of the USB memory 10 (step S40), and judges whether or not an EMF file is recorded (step S41). When an EMF file is not recorded (step S41: No), an error message is displayed to the effect that the EMF file to be printed does not exist, printing processing cannot be executed (step S44).

When an EMF file is recorded (step S41: Yes), the printing terminal 100 references EMF file header (step S42), and judges whether or not the printing terminal ID in the header is the same as the printing terminal ID of the host terminal (step S43). With this embodiment, the printing terminal ID of the printing terminal 100 is “5555,” so when the printing terminal ID is the same (step S43: Yes), in other words, when the printing terminal ID in the header is “5555,” printing processing continues. When the printing terminal ID in the header is not “5555” (step S43: No), an error is displayed to the effect that printing processing cannot be executed (step S44).

A3-3. Printing Process at the Printing Terminal:

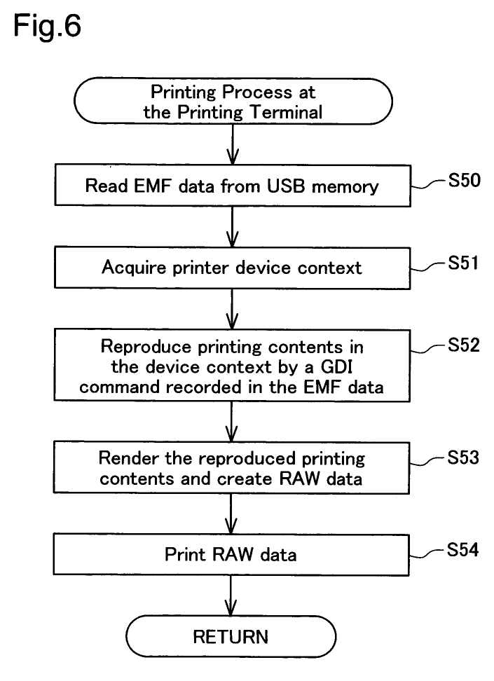

FIG. 6 is a flow chart that explains the printing process at the printing terminal 100 for this embodiment. FIG. 3 shows a process that correlates to the step S22.

The printing terminal 100 reads the EMF file from the USB memory 10 (step S50), acquires the device context of the printing terminal 100 from the printer driver 113 (step S51), and reproduces the printing contents using a GDI command recorded in the EMF file (step S52).

The printing terminal 100 does rendering of the reproduced printing contents, creates RAW data (step S53), and prints the RAW data (step S54).

With the printing system 1000 of the first embodiment explained above, the printing terminal 100 reads an EMF file on which is recorded output contents by a drawing command that does not depend on printing terminal 100 from the USB memory 10, so it is possible to perform printing regardless of the model of the printing terminal. Therefore, it is not necessary to prepare a driver according to the printing terminal model in advance, so output is performed easily. Also, since the USB memory 10 is used for transferring EMF files, it is possible to perform printing without installing an expensive device such as a server, making it possible to suppress the system construction expenses. Also, by referencing the printing terminal ID contained in the EMF file header, the printing terminal 100 can easily judge whether or not various printing settings of the EMF file, such as both sided printing or paper size selection, are suitable for printing with the host device.

B. Second Embodiment:

With the first embodiment described above, the printing terminal 100 references the recording contents of the USB memory 10, and when an EMF file is not recorded, it display an error, and stops printing processing. With this embodiment, when an EMF file is not recorded in the USB memory 10, it creates an installer that contains the general purpose printer driver 107, the characteristics data 108, and the setting information 109, and records this in the USB memory 10. The user uses this installer to install the general purpose printer driver 107, the characteristics data 108, and the setting information 109 in the printing terminal 100, and the printing terminal 100 creates an EMF file that is suitable for printing with the printing terminal 100. This embodiment has the same system configuration as the first embodiment. However, the printing terminal 100 is equipped with the functional block shown by the dotted line balloon in FIG. 2

B1. Recording Content Judgment Process:

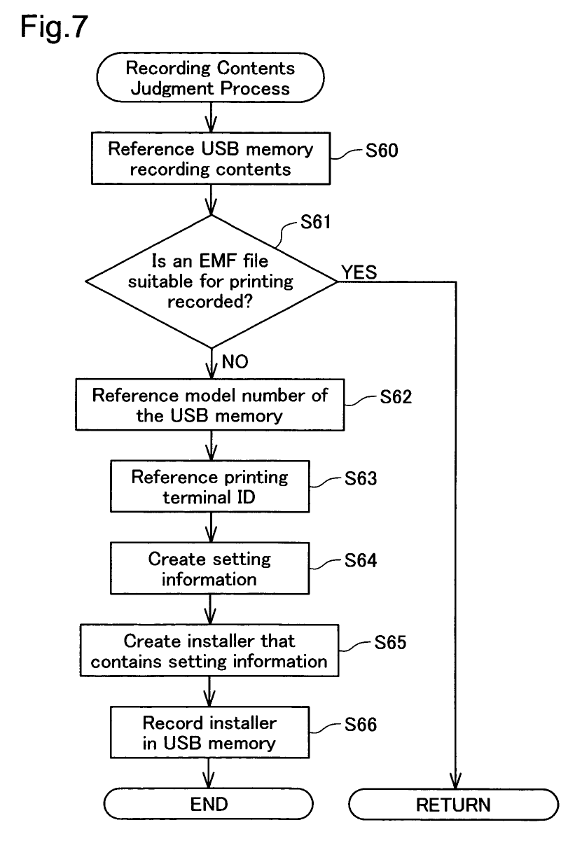

FIG. 7 is a flow chart that explains the recording content judgment process for the second embodiment. This process correlates to step S21 in FIG. 3 for the first embodiment.

The printing terminal 100 references the recording contents of the USB memory 10 (step S60), and judges whether or not an EMF file that is suitable for printing with the printing terminal 100 is recorded (step S61). This judgment process correlates to the process from step S41 to step S43 in FIG. 5. Specifically, when the judgment is “No” at step S41 and step S43, the process continues at step S62.

When the printing terminal 100 judges that an EMF file that is suitable for printing with the printing terminal 100 is recorded (step S61: Yes), the printing process is continued.

When an EMF file suitable for printing with the host terminal is not recorded in the USB memory 10 (step S61: No), the printing terminal 100 references the USB memory 10 and acquires the model number of the USB 10 (step S62) and also references the printing terminal ID of the host terminal (step S63). Next, the printing terminal 100 creates the setting information 109 which contains the model number of the memory 10 and the printing terminal ID (step S64), and creates an installer that contains the setting information 109, the general purpose printer driver 107, and the characteristics data 108 (step S65). The printing terminal 100 records the created installer in the USB memory 10 (step S66).

With the printing terminal 100 of the second embodiment explained above, even when an EMF file suitable for printing with the host terminal is not recorded in the connected USB memory 10, the setting information 109 is created from the model number of the connected USB memory 10 and the printing terminal ID of the host terminal, so it is easy to create an installer for generating an EMF file that is suitable for printing with the host terminal, and it is possible to record this on the USB memory 10. Therefore, the user can install the installer that is recorded in the USB memory 10 in the user PC 200 and create the contents to be printed as an EMF file that is suitable for printing with the printing terminal 100, so it is possible to easily print the contents one wishes to print with the printing terminal, which increases convenience.

C. Third Embodiment

C1. System Configuration

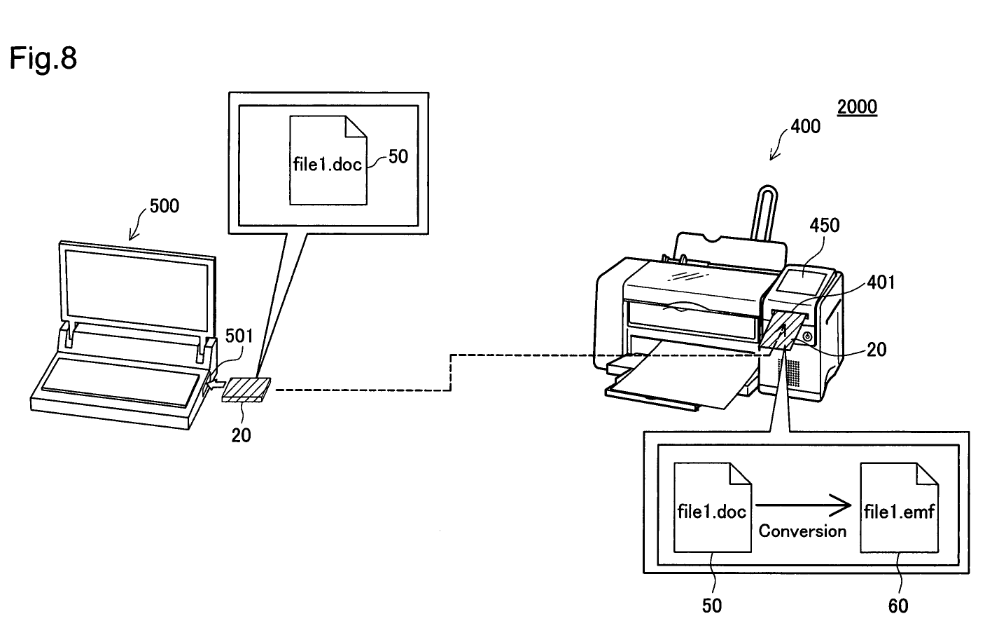

FIG. 8 is an explanatory diagram that shows an embodiment of the system configuration of the printing system 2000 of a third embodiment. The printing system 2000 is formed from a printer 400, a user PC 500, and a card PC 20. Sending and receiving of information is performed via the card PC 20 between the printer 300 and the user PC 500, and printing is executed.

The card PC 20 is a computer of the PC card type that is equipped with a CPU, memory, hard disk, and a PCMCIA connectable interface, and functions as the portable recording medium of the present invention. This is not limited to a PCMCIA connectable interface, and for example, can also be a USB connectable interface, or an interface that is connectable to both the printer and the computer used by the user. A Windows OS is installed in the card PC 20, and a function is incorporated that converts various format files to EMF files that can be interpreted by the printer 400. The user PC is a general notebook personal computer, and is equipped with a PC card slot 501 as an interface that can connect to a card PC. The printer 400 is a printer that is equipped with a PC card slot 401 and an operating panel 450.

The user connects the card PC 20 to the PC card slot 501 of the user PC 500, and stores the printing file 50 he wishes to print in the card PC 20. The printing file 50 is text data with a file name of “file.doc”.

Next, the user changes insertion of the card PC 20 from the user PC 500 to the printer 400. With connection to the printer 400 as a trigger, the card PC 20 receives a supply of power from the printer 400, and as shown in the figure, converts the printing file 50 to an EMF file 60, and outputs this to the printer 400. The card PC 20 receives, for example, specification data such as the resolution, or, for example, setting data such as the paper size from the printer 400, and based on these, converts the printing file 50 and creates an EMF file 60.

The printer 400 converts the EMF file 60 that was output from the card PC 20 to RAW format data, and executes printing.

C2. Functional Block

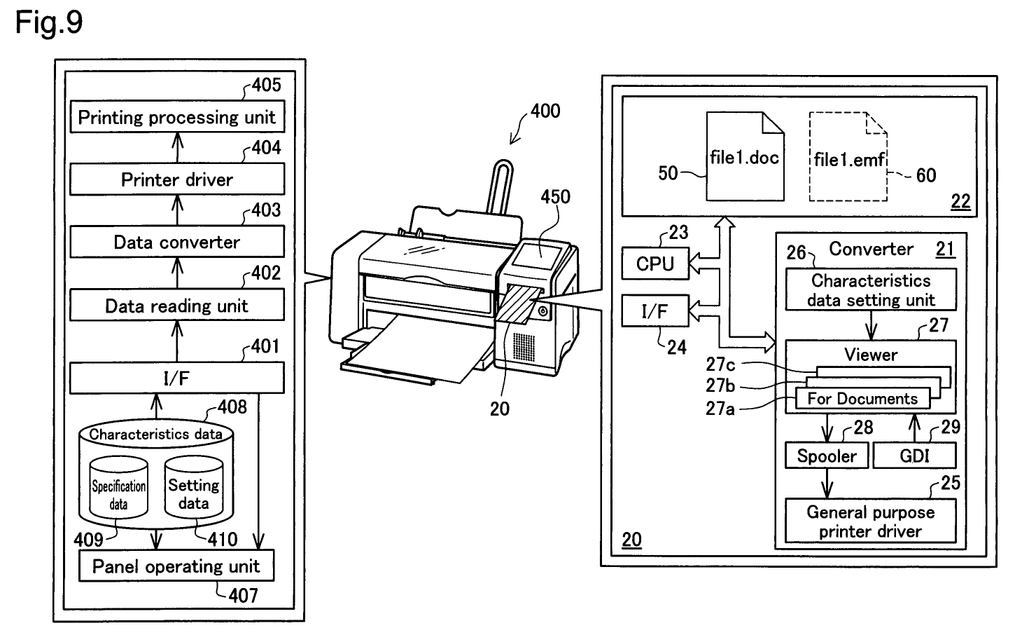

FIG. 9 is an explanatory diagram that shows an embodiment of the card PC 20 and the printer 400 functional block for this embodiment. The card PC 20 has a converter 21, a file storage area 22, a CPU 23, and an interface 24. The converter 21 is formed from a characteristics data setting unit 26, a viewer 27, a spooler 28, a GDI 29, and a general purpose printer driver 25. The interface 24 is a card bus, and is equipped with a function for performing sending and receiving of information with the printer 400. The converter 21 is formed as software. Each of the functional blocks of the card PC 20 is controlled by the CPU 23.

The characteristics data setting unit 26 acquires the characteristics data from the printer 400. The characteristics data includes specification data 409 inherent to the printer 400 such as the resolution, and print setting data 410 which can be set when printing by the user, such as the paper size. The characteristics data setting unit 26 acquires data input by the user from the operating panel 450 for the printing setting data 410 of the characteristics data storage unit 408.

The viewer 27 is software equipped with a file content display and printing function. When the viewer 27 detects that the card PC 20 is connected to the PC card slot 401 via the interface 24, it calls the drawing command of the GDI 129 which is one of the modules that forms the OS kernel, creates an EMF format file, and stores it in the spooler 28. When creating the EMF file, the viewer 27 uses the acquired characteristics data and sets information relating to, for example, paper size and resolution, both sided printing, borderless printing, and layout printing. For the viewer 27, for example, when converting a document format file, the text data viewer 27a is used, and when converting a spread sheet format file, the spread sheet viewer 27b is used, with preparation done for each type of file data.

For this embodiment, for convenience of explanation, the printing file 50 which is subject to printing is text data. In this case, the converter 21 uses the text data viewer 27a and creates the EMF file 60.

The general purpose printer driver 25 sequentially reads the EMF files stored in the spooler 28, and stores them in the file storage area 22. In the figure, the EMF file 60 stored in the file storage area 22 is shown by the dotted line.

The printer 400 comprises a PC card slot (I/F) 401, a data reading unit 402, a data converter 403, a printer driver 404, a printing processing unit 405, a panel control unit 407, and a characteristics data storage unit 408. The printer 400 incorporates a control unit equipped with internal CPU, RAM, and ROM, and the data reading unit 402, the data converter 403, the printer driver 404, and the panel control unit 407 are formed as software by firmware executed by the control unit.

The characteristics data storage unit 408 stores characteristics data that shows specified characteristics of the printer 400. As explained previously, the characteristics data includes the specifications data 409 and the printing setting data 410. The characteristics data storage unit 408 transfers characteristics data according to characteristics data acquisition requests from the card PC 20.

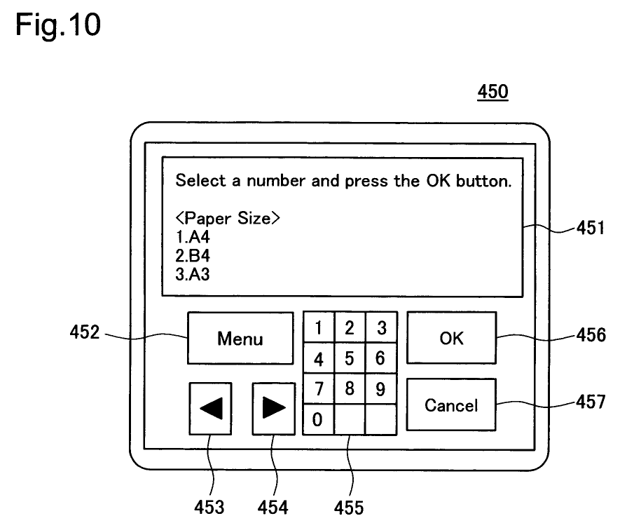

The panel control unit 407 controls the operating panel 450. Specifically, it receives display instructions from the characteristics data setting unit 26, displays the characteristics data on the operating panel 450, and transfers the contents input by the user to the card PC 20. We will explain the operating panel 450 using FIG. 10.

FIG. 10 is an explanatory diagram that shows an embodiment of an operating panel 450. The operating panel 450 is formed from a display unit 451, a menu button 452, selection buttons 453 and 454, number keys 455, setting button 456, and cancel button 457. As shown in the figure, a message that prompts the user to select the paper size is displayed on the display unit 451. The user makes a selection using the number keys 455 and presses the setting button 456. The selected printing setting data is transferred to the card PC 20. By pressing the menu button 452 or the selection buttons 453 and 454, it is also possible to have the printing setting data menu, for example, both sides printing, multi page printing, expansion and reduction, etc. displayed.

We will continue the explanation by returning to FIG. 9. The data reading unit 402 reads the EMF file 60 output by the card PC 20, and transfers this to the data converter 403. The data converter 403 acquires the device context of the printer 400 from the printer driver 404 and reproduces the printing contents by a GDI command that is recorded in the EMF file 60. The printer driver 404 creates RAW data that is suitable for the printer 400 according to the concerned printing contents, and transfers this to the printing processing unit 405. The printing processing unit 405 prints the RAW data.

C3. Conversion Process:

C3-1. Data Storage Process:

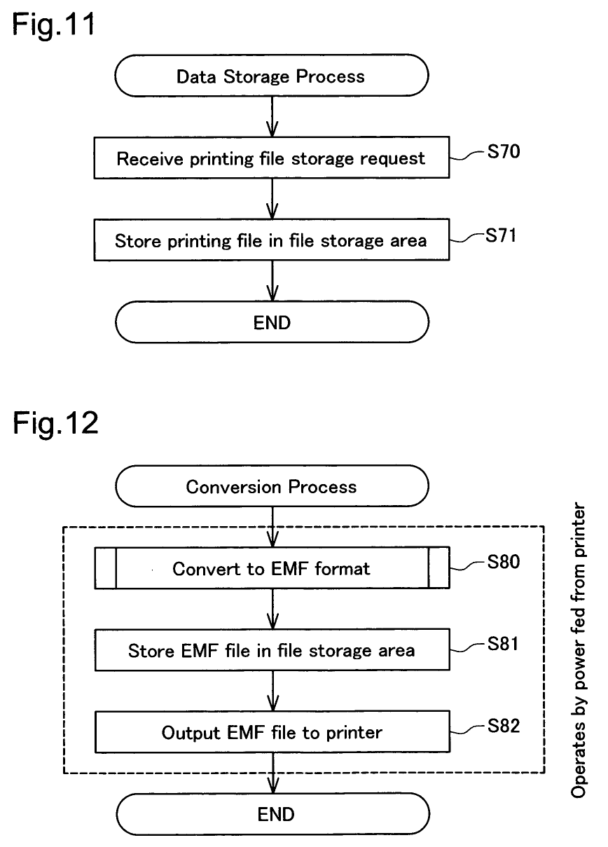

FIG. 11 is a flow chart that explains the data storage process for this embodiment. This process is started by connecting the card PC 20 to the user PC 500.

The card PC 20 receives a request to store the printing file 50 to be printed by an operation by the user (step S70), and stores the concerned printing file 50 in the file storage area 22 (step S71).

C3-2. Output Process:

FIG. 12 is a flow chart that explains the output process performed by the card PC 20 with this embodiment. The output process is started by connecting the card PC 20 to the printer 400. The card PC 20 performs processing using power fed from the printer 400.

The card PC 20 converts the printing file stored in the file storage area 22 to an EMF format while sending and receiving information with the printer 400, and creates an EMF file (step S80). The details of the conversion process will be described later.

Next, the card PC 20 stores the created EMF file in the file storage area 22 (step S81), and outputs it to the printer 400 (step S82).

A3-3. Conversion Process:

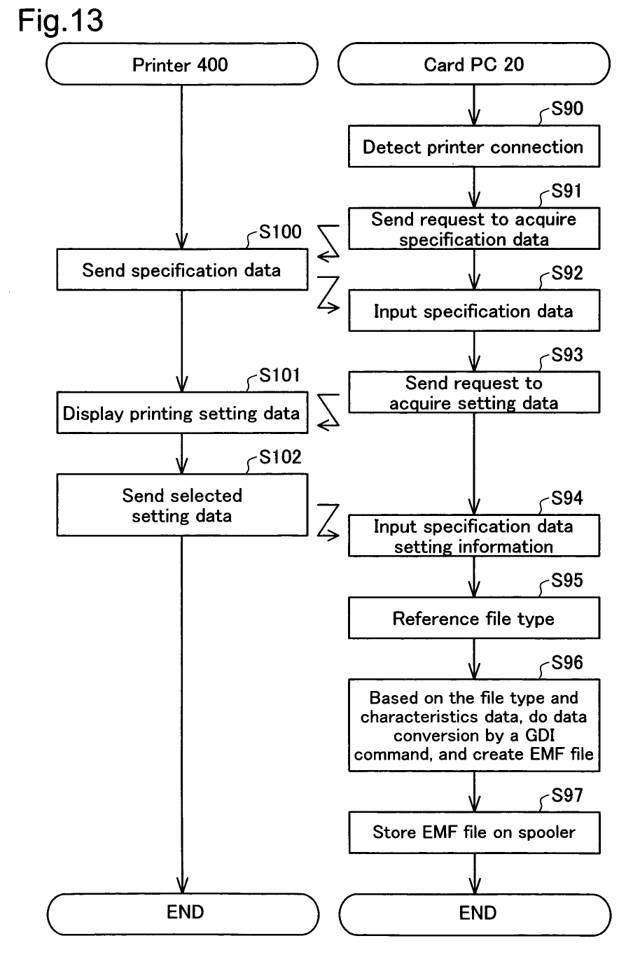

FIG. 13 is a flow chart that explains the details of the conversion process for this embodiment. This process correlates to step S80 in FIG. 12.

When the card PC 20 detects that the card PC 20 is connected to the printer 400 (step S90), it sends a request to acquire the specification data 409 to the printer 400 (step S391).

When the printer 400 receives this acquisition request, it sends the specification data 409 to the card PC 20 (step S100).

The card PC 20 receives the specification data 409 and transfers it to the viewer 27 (step S92), and sends a request to acquire the printing setting data 410 (step S93).

When the printer 400 receives this acquisition request, it displays an interface screen for setting the printing setting data 410 on the operating panel 450 (step S101), receives a selection from the user, and sends the selected printing setting data 410 to the card PC 20 (step S102). The interface screen can be generated to reflect the contents of the specification data 409. For example, the setting screen of whether or not to perform both sided printing can be displayed only when the specification data 409 that shows that the printer 400 is capable of both sided printing is received.

The card PC 20 receives the specification data 409 and transfers it to the viewer 27 (step S94). Next, it references the printing file data format and determines a viewer to use for converting to the EMF format (step S95). The card PC 20 uses the determined viewer and performs data conversion using a GDI command, and creates an EMF file that reflects the characteristics data (step S96). Then, the created EMF file is stored in the spooler 28 (step S97).

C4. Printing Process:

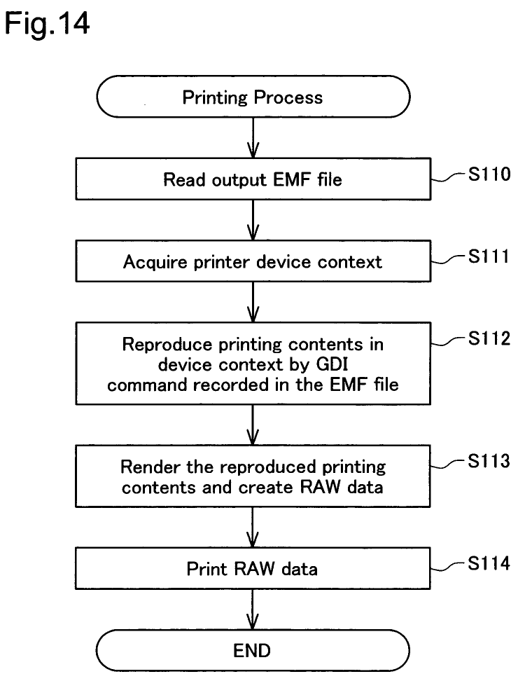

FIG. 14 is a flow chart that explains the printing process for this embodiment. This is a process that is performed with the printer 400 controlling each functional block.

The printer 400 reads the EMF file output from the card PC 20 (step S10), acquires the device context of the printer 400 from the printer driver 404 (step S111), and reproduces the printing contents by a GDI command that is recorded in the EMF file (step S112).

Next, the printer 400 performs rendering of the reproduced printing contents, converts this to RAW format, creates RAW data (step S113), and prints (step S114).

With the card PC 20 of the third embodiment explained above, by storing the printing data he wishes to print in the card PC 20, the user is able to convert to an EMF file and output to a printer. Therefore, the user is able to print files of various data formats easily without installing a driver inherent to the printer 400 to his own computer in advance.

Also, because the specification data of the printer 400 and the printing setting data 410 are reflected in the converting process, it is possible to create an EMF file that is suitable for printing with the printer 400.

D. Fourth Embodiment:

With the third embodiment described above, the characteristics data was acquired from the printer 400. With the fourth embodiment, the characteristics data is stored in advance in the card PC, and the card PC creates an EMF file specific to that printer. With the fourth embodiment, the printer uses a printer ID to identify the fact that this is an EMF file specific to that printer, a printer ID is used. The system configuration for this embodiment is the same as that of the third embodiment, so an explanation is omitted here.

D1. Functional Block:

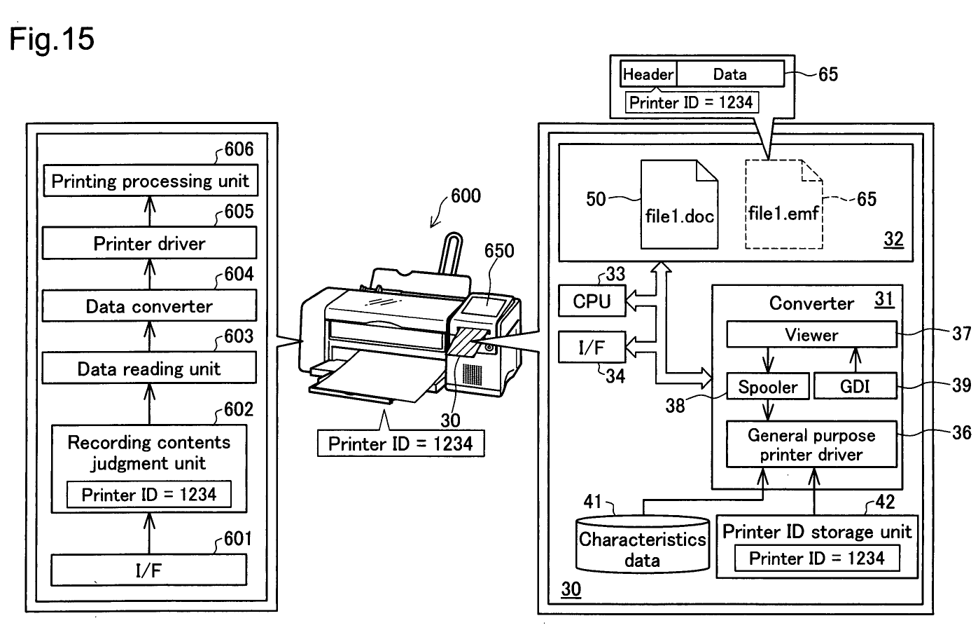

FIG. 15 is an explanatory diagram that shows an embodiment of the printer 600 and the card PC 40 functional block. The card PC 30 consists of a converter 31, a file storage area 32, a CPU 33, an interface 34, a characteristics data storage unit 41, and a printer ID storage unit 42. The converter 31 consists of a viewer 37, a spooler 38, a GDI 39, and a general purpose printer driver 40. The interface 34 is a card bus of the printer 60, and sends and receives information with the printer 600. The card PC 30 is controlled by the CPU 33.

The file storage area 32 is an area for storing printing files one wishes to print and EMF files after conversion of those printing files. As shown in the figure, a printing file 50 stored by the user and an EMF file 70 after conversion of the printing file 50 are stored in the file storage area 32. It is also possible to divide the file storage area 32 into areas for storing printing files and EMF files, for example.

The characteristics data storage unit 41 stores characteristics data that shows specified characteristics of the printer 600.

The printer ID storage unit 42 stores a printer ID of the printer set to be the output destination of the printing data stored in the card PC 30. A printer ID is a number allocated uniquely to a printer. For example, the manufacturing number may be used.

The viewer 37 is software that includes a file contents display and a printing function. It has the same structure as the viewer 27 of the third embodiment. When the viewer 37 detects a connection to the printer 600, it calls the drawing command of the GDI 39, creates an EMF format file, and stores this in the spooler 38. When creating an EMF file, the viewer 37 references the printer ID storage unit 42, and allocates a printer ID to the header of the EMF file. With this embodiment, as shown in the figure, “printer ID =1234” which is the printer ID of the printer 600 is allocated to the header of the EMF file 70.

The general purpose printer driver 40 sequentially reads the EMF files stored in the spooler 38, and as shown by the dotted line in the figure, stores them in the file storage area 22.

The printer 600 consists of a PC card slot 601, a recording contents judgment unit 602, a data reading unit 603, a data converter 604, a printer driver 605, and a printing processing unit 606. The recording contents judgment unit 602, the data reading unit 603, the data converter 604, and the printer driver 605 are all formed as software.

When the recording contents judgment unit 602 detects that the card PC 30 is connected to the PC card slot 601, it judges whether or not an EMF file is stored in the card PC 30. Furthermore, when an EMF file is stored, the header of that EMF file is referenced, and a judgment is made of whether or not that is a file suitable for printing with the printer 600. In specific terms, with this embodiment, if the printer ID of the printer 600 is set in the header of the EMF file, it is judged that an EMF file of a format suitable for the printer 600, specifically that is based on the characteristics data of the printer 600, has been created. When an EMF file is not recorded in the card PC 30 or when it is judged that the EMF file is not of a format that is suitable for the printer 600, the recording contents judgment unit 602 can also be made to display an error message and stop processing.

When it is judged that an EMF file that is suitable for printing with the printer 600 is recorded in the card PC 30 by the recording contents judgment unit 602, the data reading unit 603 reads the EMF file and transfers it to the data converter 604. The data converter 604 acquires the device context of the printer 600 from the printer driver 605 and reproduces the printing contents by a GDI command recorded in the EMF file 70. The printer driver 605 creates RAW data suitable for the printer 600 according to the printing contents, and transfers this to the printing processing unit 606. The printing processing unit 606 prints this RAW data.

D2: Conversion Process:

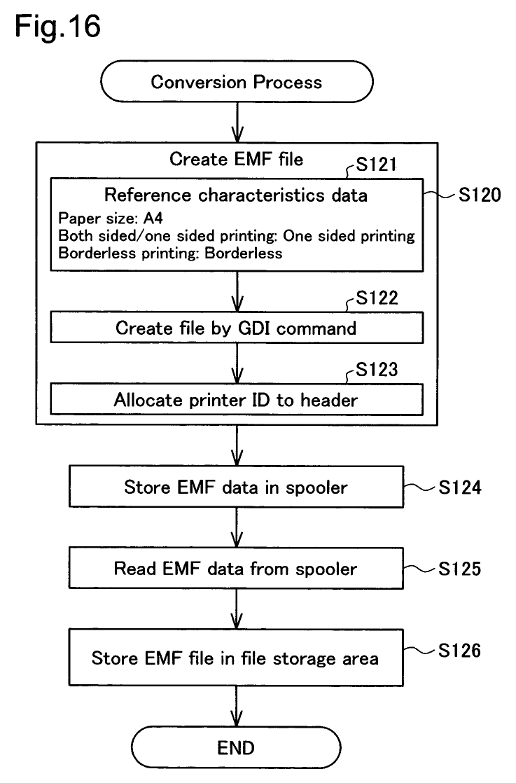

FIG. 16 is a flow chart that explains the process of converting to an EMF format for this embodiment. The card PC 30 starts the conversion process when it is in a state connected to the user PC and it is detected that a printing file is stored in the card PC 30. The card PC 30 has power fed from the user PC 500, and performs this conversion process. The execution timing of the conversion process can be set in various ways, such as being at the point that the card PC 30 is connected to printer.

The card PC 30 creates an EMF file from the printing file 50 that is stored in the file storage area 32 (step S120). In specific terms, the following process is performed. The card PC 30 references the characteristics data of the printer 600, such as the paper size, for example (step S121). Next, using this characteristics data, an EMF file correlating to the printing contents is created by a GDI command (step S122), the printer ID storage unit 42 is referenced, and a printer ID is allocated to the header (step S123).

The card PC 30 stores EMF files created as described above in the spooler 38 (step S124). Next, the general purpose printer driver 40 reads the EMF file from the spooler 38 (step S125), and stores this in the file storage area 32 (step S126).

D3. Printing Process:

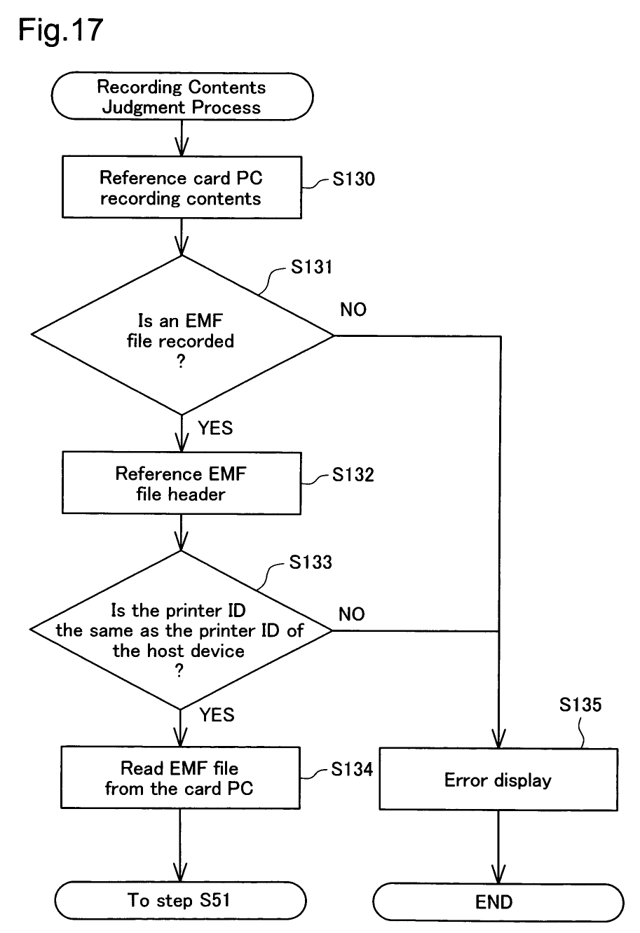

FIG. 17 is a flow chart that explains the recording contents judgment process for this embodiment. This is a process that is performed before step S111 of FIG. 14 of the third embodiment. Also, with this embodiment, step S110 is omitted.

The printer 600 eferences the recording contents of the card PC 30 (step S130) and judges whether or not an EMF file is recorded (step S131). When an EMF file is not recorded (step S131: No), an error display is shown to the effect that the EMF file to be printed does not exist, and it is not possible to execute printing processing (step S135).

When an EMF file is recorded (step S131: Yes), the EMF file header is referenced (step S132), and a judgment is made of whether or not the printer ID in the header is the same as the printer ID of the host device (step S133). With this embodiment, since the printer ID of the printer 600 is “1234,” when the printer ID is the same (step S133: Yes), specifically, when the printer ID in the header is “1234,” the EMF file is read from the card PC 30 (step S134), and the process continues to step S111 in FIG. 14 and printing processing is performed. When it is not the same (step S113: No), an error display is shown to the effect that printing processing cannot be executed (step S115).

With the card PC 30 of the fourth embodiment described above, the same as with the card PC of the third embodiment, by storing the printing data he wishes to print in the card PC, the user is able to convert to EMF data that reflects the printer characteristics. Therefore, it is possible for the user to output files of various data formats in a state that is suitable for printing with the printer without installing a printer specific driver in his own computer in advance.

Also, by storing the characteristics data in the card PC 30 and allocating a printer ID to the header of the EMF file in advance, it is possible to perform printing only with a predetermined printer. By doing this, it is possible to correlate the printer and the card PC to manage them. It is possible to have an embodiment that provides a printing service with distribution of card PCs that can print only with printers installed in each room at an accommodation facility such as a hotel.

E. Variation Embodiment:

Above, we explained various embodiments of the present invention, but the present invention is not limited to these, and it is obvious that it is possible to use various structures within a scope that does not stray from the key points. For example, it is also possible to form the printing terminal as an output terminal that has a function as a projector or a display.

E1. Variation Embodiment 1:

With the first embodiment described above, USB memory was used as the portable recording medium, but the invention is not limited to this. For example, a flexible disk or CD-ROM may also be used. It is acceptable as long as the recording medium can be carried easily.

E2. Variation Embodiment 2:

With the first embodiment noted above, to make a judgment of suitability for printing with a printing terminal, we included a printing terminal ID allocated uniquely to a printing terminal in the EMF file header, but the invention is not limited to this. It is also possible to make a judgment of suitability for printing with a printing terminal based on printing characteristics such as the printing terminal model number, paper size, or both sided printing, etc.

E3. Variation Embodiment 3:

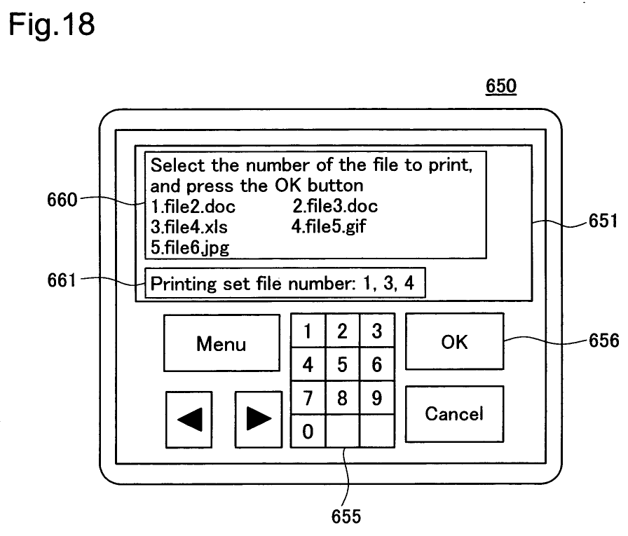

FIG. 18 is an explanatory diagram that shows an embodiment of an operating panel 650 for a variation (embodiment of the third embodiment. The card PC 20 displays all the stored files on the operating panel 650 of the printer 600 and has the user select a file to print. Then, it is also possible to have the selected file converted to EMF format to create an EMF file. Displayed in the display unit 651 are a selection message 660 and the decision contents 661. The printing file stored in the card PC 20 is displayed in the selection message 660. The user uses the number keys 655 to select the number of the printing file he wishes to print, and presses the OK button 656. By doing this, it is possible to confirm and select the stored printing file again before executing printing.

It is also possible to set the printing settings, such as paper size, both sided printing, and multi pages, for each selection of a file, with settings made individually for each file. By doing this, it is possible to make individual printing settings for multiple files.

E4. Variation Embodiment 4:

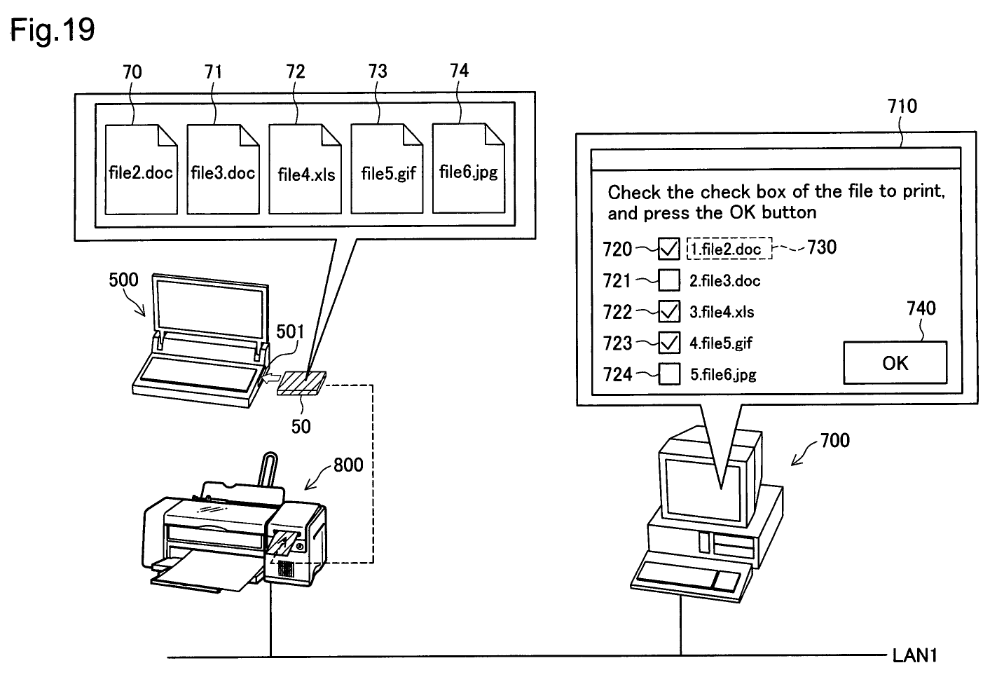

With the third embodiment described above, the printer 400 was equipped with an operating panel. With this variation embodiment, as explained below, when connecting a card PC to a printer which is not equipped with an operating panel, things such as selection of the file to be printed and setting of the characteristics data, for embodiment, are displayed on the display of a computer that is connected to the same network as the printer, and the user performs things such as selection of the file to be printed or input of characteristics data, for embodiment, from the computer. A detailed explanation will be given using FIG. 19.

FIG. 19 is an explanatory diagram that shows an embodiment of a printing system for this variation embodiment. The printer 800 is a printer that is not equipped with an operating panel, and is connected to the local area network LAN 1. The computer 700 is connected to the same local area network LAN 1 as the printer 800, and is equipped with a function of displaying various information relating to the printer 800 based on instructions from the printer.

As shown in the figure, multiple printing files 70 to 74 are stored in the card PC 50. When the printer 800 detects that the card PC 50 is connected, it sends instructions to display the printing files 70 to 74 stored in the card PC 50 on the display of the computer 700 via the network. As shown in the figure, the computer 700 displays a selection window 710. Displayed in the selection window 710 are the file name and check box such as shown by the file name 730 and the check box 720, and the user checks the check box of the file he wishes to print and then presses the OK button 740. When the computer 700 detects that the OK button 740 has been pressed, it notifies the printer 800 of the selected printing file. The printer 800 notifies the card PC 50 of the received notification contents. The card PC 50 converts the selected printing file.

By doing this, even when a printing device is not equipped with an operating panel, it is possible to select a file to be printed and to make settings of the printing settings such as the paper size setting. It is also possible to have a local connection for the printer 800 and the computer 700.

E5. Variation Embodiment 5:

With the fourth embodiment described above, we had the card PC 30 provided with the characteristics data and printer ID of the printer 600 in advance, but the invention is not limited to this. For example, it is also possible to provide characteristics data of multiple printers with different specifications and with printer IDs that correspond to these. In this case, for example, it is possible to form a different folder for each printer in advance, in other words, to form different storage areas, and to have the user store the printing file in the folder that corresponds to a printer he wants to print on. The card PC 30 uses the printer characteristics data corresponding to each folder to create EMF files, and by allocating the respectively corresponding printer ID to the header of the EMF file header, realization is easy. By doing this, it is possible to print printing files to match the printer specifications, which increases convenience.

E6. Variation Embodiment 6:

It is also possible to have, for example, the printer equipped with a function of calculating the amount of money correlating to use from the consumption volume of consumable supplies, such as the number of sheets of paper and ink volume used for printing, for example, and to have the card PC equipped with a function of gathering from the printer the calculated monetary amount, or so called accounting information, and storing this in the file storage area. By doing this, for example at a hotel, when using a printing system using the card PC of the present invention, it is possible to easily settle the account for printing.

The Japanese patent applications as the basis of the priority claim of this application are incorporated in the disclosure here of by reference:
(1) Japanese Patent Application No. 2004-22374 (filing date: Jan. 30, 2004).
(2) Japanese Patent Application No. 2004-26580 (filing date: Feb. 3, 2004).
(1) Japanese Patent Application No. 2004-83799 (filing date: Mar. 23, 2004).

1. A data output method in an image output device, the output method comprising steps of:
(a) reading first output data from a portable recording medium, wherein the portable recording medium storing the first output data that is described output contents with a drawing command, wherein the drawing command does not depend on the output device;
(b) judging whether the first output data is suitable for output at the output device based on the first output data;
(c) converting the first output data to second output data that is interpretable by the output device, when it is judged that the first output data is suitable for output at the output device;
(d) performing image output processing using the second output data.

2. A data output method in accordance with claim 1, wherein the judgment at step (b) is executed based on identification information for identifying the output device, the identification information is contained in the first output data.

3. A data output method in an output system that comprises a data generating device, an output device, and a portable recording medium, wherein the portable recording medium is used for sending and receiving of data between the data generating device and the output device, and includes computer program command for generating the first output data that is described with a drawing command, wherein the drawing command does not depend on the output device, and computer program commands for saving the first output data into the portable recording medium, the method comprising steps being executed by the data generating device:
(a) installing the computer program from the portable recording medium to the generating device; and
(b) executing the computer program, the method comprising steps that being executed by the output device:
(c) reading the first output data from the portable recording medium;
(d) converting the first output data to second output data that it interpretable by the output device; and
(e) performing output processing on the second output data.

4. An output device that performs image output using a first output data for which the output contents are described with a drawing command, wherein the drawing command is recorded on a portable recording medium and does not depend on the output device, the output device comprising:
a reading module that reads the first output data from the portable recording medium;
a judgment module that judges whether the first output data is suitable for the output device based on the first output data;
a converter that converts the first output data to second output data that is interpretable by the output device when the first output data is judged to be suitable for output at the output device; and
an output processing module that outputs image of the second output data.

5. A portable recording medium storing a computer program so as to be readable by a computer, wherein
the computer program comprises:
a program command that converts the output data that is an image or text to be output into intermediate data that is described with a drawing command, wherein the drawing command does not depend on the output device; and
a program command that specifies the portable recording medium as the saving destination of the intermediate data, regardless of the specification of the saving destination.

6. A portable recording medium in accordance with claim 5, wherein
the portable recording medium is hot swappable.

7. A portable recording medium in accordance with claim 5, wherein
the conversion is performed based on characteristics data that shows specified characteristics of the output device.

8. A portable recording medium in accordance with claim 5, wherein
the portable recording medium comprises identification information by which it is recognizable itself; and
the specification of the saving destination is specified based on the identification information.

9. A portable recording medium in accordance with claim 5, wherein
the first output data is EMF format data.

10. A data output system that comprises a data generating device, an output device, and a portable recording medium, wherein the portable recording medium is used for sending and receiving of data between the data generating device and the output device, wherein
the portable recording medium comprises a computer program for realizing on a computer functions of:
generating data to be output as first output data that is described with a drawing command, wherein the drawing command does not depend on the output device; and
saving the first output data with the portable recording medium as the saving destination,
the data generating device comprises:
a portable recording medium interface;
an installation processing module that installs the computer program from the portable recording medium to the data generating device; and
an execution module that executes the computer program the output device comprises:
a reading module that reads the first output data from the portable recording medium;
a converter that converts the first output data to second output data that is interpretable by the output device; and
an output processing module that outputs the image of the second output data.

11. A recording medium that stored a computer program, wherein the computer program is readable by a computer, the recording medium comprising:
a program command to read first output data from the portable recording medium, wherein the portable recording medium stores the first output data the output contents are described with a drawing command, wherein the drawing command does not depend on the output device that outputs image data;
a program command that judges whether the first output data is suitable for output at the output device based on the first output data;
a program command that converts the first output data to second output data that is interpretable by the output device based on the results of the judgment; and
a program command that executes the output processing of the image of the second output data.

12. A data output method in a portable recording medium that comprises a connection interface for locally connecting both a data generating device that generates data that is either image or text to be output and an output device that outputs either the image or text based on the data, wherein the data output method comprising steps of:
(a) receiving and storing the data from the data generating device;
(b) storing characteristics data that shows specified characteristics of the output device; and
(c) converting the stored data to intermediate data described with a drawing command, wherein the drawing command does not depend on the output device, based on the characteristics data, and transferring the intermediate data to the output device.

13. A data output method in accordance with claim 12, wherein t
he portable recording medium further comprises a step of:
(d) acquiring the characteristics data from the output device.

14. A data output method in accordance with claim 12, wherein
the portable recording medium, further comprises a step of;
(e) displaying an interface screen for the user to make settings for at least part of the characteristics data on the display unit of the output device.

15. A data output method in accordance with claim, 12 wherein
the portable recording medium is hot swappable.

16. A data output method in accordance with claim 12, wherein
the conversion in step (c) is done using the converter provided individually according to the data format type of the data.

17. A data output method in a portable recording medium that has a connection interface for locally connecting both a data generating device that generates data that is either image or text to be output and an output device that outputs either the image or text based on the data, the data output method comprising steps of:
(a) storing the data;
(b) converting the stored data to intermediate data that is described with a drawing command, wherein the drawing command does not depend on the output device;
(c) detecting that the portable recording medium is connected to the output device; and
(d) outputting the intermediate data to the output device with the detection as the trigger.

18. A data output method in accordance with claim 17, further comprising a step of:
(e) holding the characteristics data that shows the specified characteristics of the output device; and
the conversion in step (b) is done based on the characteristics data.

19. A data output method according to claim 17, wherein
the portable recording medium is hot swappable.

20. A data output method in accordance with claim 17, wherein
the conversion in step (b) is done using the converter provided individually according to the data format type of the data.

21. A portable recording medium comprising:
a data generating device that generates data that is either image or text to be output, an output device that outputs either the image or text based on the data, and a connection interface for locally connecting each of these;
a data storage module that receives and stores the data from the data generating device;
a characteristics data storage module that stores characteristics data that shows specified characteristics of the output device; and
a converter that, based on the characteristics data, converts the stored data to intermediate data described with a drawing command, wherein the drawing command does not depend on the output device, and transfers intermediate data to the output device.

22. A portable recording medium comprising:
a data generating device that generates data that is either image or text to be output, an output device that outputs either the image or text based on the data, and a connection interface for locally connecting each of these;
a data storage module that stores the data;
a converter that converts the stored data to intermediate data described with a drawing command, wherein the drawing command does not depend on the output device;
a detection module that detects that the portable recording medium is connected to the output device;
an output module that outputs the intermediate data to the output device; and
an output control module that performs the conversion and the output with the detection as the trigger.

23. An output system that comprises a data generating device, an output device, and a portable recording medium, wherein the portable recording medium sends and receives data between the data generating device and the output device, wherein
the data generating device comprises:
a portable recording medium interface; and
an input module that inputs the data that is an image or text to be output to the portable recording medium,
the portable recording medium comprises:
a connection interface for locally connecting both a data generating device and an output device that outputs either the image or text based on the data;
a data storage module that receives and stores the data from the data generating device;
a characteristics data storage module that stores characteristics data that shows specified characteristics of the output device; and
a converter that, based on the characteristics data, converts the stored data to intermediate data that is described with a drawing command wherein the drawing command does not depend on the output device, and transfers this to the output device,
the output device comprises:
a reading module that reads the intermediate data recorded in the portable recording medium;
a data converter that converts the intermediate data to output data that is interpretable by the output device; and
an output processing module that executes output processing of the image or text of the output data.

24. An output system that comprises a data generating device, an output device, and a portable recording medium, wherein the portable recording medium sends and receives data between the data generating device and the output device, wherein
the data generating device comprises:
a portable recording medium interface; and
an input module that inputs data that is an image or text to be output to the portable recording medium,
the portable recording medium comprises:
a connection interface for locally connecting both the data generating device and an output device that outputs the image or text based on the data;
a data storage module that receives the data from the data generating device and stores it;
a converter that converts the stored data to intermediate data that is described with a drawing command, wherein the drawing command does not depend on the output device;
a detection module that detects that the portable recording medium is connected to the output device;
an output module that outputs the intermediate data to the output device; and
an output control module that performs the conversion and the output with the detection as a trigger, and the output device comprises:
a reading module that reads the intermediate data output from the portable recording medium;
a data converter that converts the intermediate data to output data that is interpretable by the output device; and
an output processing module that executes output processing of an image or text of the output data.
